(19) United States
(12) Patent Application Publication
(10) Pub. No.: US 2024/0269973 A1
(43) Pub. Date: Aug. 15, 2024

(54) BIOMIMETIC POLYMER MULTILAYER STRUCTURE WITH METALLIC FEEL, AND MANUFACTURING METHOD THEREOF

(71) Applicant: INDUSTRY-ACADEMIC COOPERATION FOUNDATION, DANKOOK UNIVERSITY, Yongin-si (KR)

(72) Inventors: Young Seok SONG, Seoul (KR); Ji Won JEONG, Yongin-si (KR)

(73) Assignee: INDUSTRY-ACADEMIC COOPERATION FOUNDATION, DANKOOK UNIVERSITY, Yongin-si (KR)

(21) Appl. No.: 18/641,738

(22) Filed: Apr. 22, 2024

Related U.S. Application Data
(63) Continuation of application No. PCT/KR2021/015216, filed on Oct. 27, 2021.

(30) Foreign Application Priority Data
Oct. 26, 2021 (KR) 10-2021-0143848

(51) Int. Cl. B32B 27/08; B32B 27/20; B32B 38/00

(52) U.S. Cl. CPC B32B 27/08; B32B 27/20; B32B 38/0012; B32B 2038/0028; B32B 2250/24; B32B 2305/30; B32B 2307/7376

(57) ABSTRACT

Proposed is a polymer multilayer structure with a metallic feel including two or more polymer layers having respectively different types of polymers having respective refractive indices that differ by 0.3 or more, the two or more polymer layers being stacked alternately, each of the polymer layers having a predetermined thickness in a range of 95 to 195 nm, independently of each other, and at least one polymer layer of the layers contains guanine as a plate-like pigment. A method of manufacturing the same polymer multilayer structure is also proposed.

### CROSS-REFERENCE TO RELATED APPLICATIONS

This application is a continuation of International Application No. PCT/KR2021/015216 fled on Oct. 27, 2021, which claims priority to Korean Patent Application No. 10-2021-0143848 filed on Oct. 26, 2021, the entire contents of which are herein incorporated by reference.

### TECHNICAL FIELD

The present disclosure relates to a polymer material with a metallic feel that exhibits metal-like properties in terms of color, gloss, and texture, and a method of manufacturing the same.

### BACKGROUND ART

Polymer materials such as plastics have advantages such as excellent functionality, formability, lightness, and low cost. However, the color, texture, and feel perceived from the exterior of the materials are inferior to those of other materials such as ceramics and metals.

Therefore, the widespread perception of polymer materials is that polymer materials are inexpensive.

Accordingly, interest in surface decoration technology is increasing as a means of improving the color, texture, and aesthetics of polymer materials. Recently, this surface decoration technology for polymer materials has not only been used to improve the appearance and exterior, which is the original purpose of decoration. Going further, the technology has also been deployed as a functional “enhancer” that gives, for example, electrical/optical functions, antibacterial functions, charging functions, anti-viral functions, and surface tactile functions. In addition, the need for dry-based decoration methods instead of wet-based decoration methods such as painting is increasing.

Additionally, polymer multilayer structures, which are obtained by dispersing heterogeneous materials such as metals and ceramics in polymers, not only can improve the color, texture, and aesthetics of polymer materials but can also implement various functions that cannot be realized in materials made of only polymers.

In the meanwhile, recently, requirements for product design are diversifying across al industries, including the automobile industry, and the perspective of product selection is evolving. Now, not only factors like performance requirements such as a product price and functionality but also factors like a feel, high quality, and convenience are considered for the product selection. Due to this trend change, the use of metal-textured point parts in automobile interior parts is also on the rise. Plating and painting methods are most commonly used to achieve metal texture. However, due to environmental issues, research on composite materials with a metallic feel is steadily increasing to impart a metallic feel to the composite materials through a single-part injection process.

### SUMMARY

### Technical Problem

The technical task to be dealt with by the present disclosure is to provide a polymer multilayer structure with a metallic feel that exhibits properties similar to those of metals in appearance such as in color, gloss, and texture, and a method of manufacturing the same.

### Technical Solution

To deal with the technical task, a polymer multilayer structure with a metallic feel is proposed. The polymer multilayer structure includes two or more polymer layers having respectively different types of polymers having respective refractive indices that differ by 0.3 or more, the two or more polymer layers being stacked alternately. Each of the polymer layers has a predetermined thickness in a range of 95 to 195 nm, independently of each other. At least one polymer layer of the two or more polymer layers contains guanine as a plate-like pigment.

In addition, a polymer multilayer structure with a metallic feel is proposed, in which, among the polymer layers constituting the polymer multilayer structure with the metallic feel, the polymer contained in the guanine-containing polymer layer and guanine have a refractive index difference of 0.3 or more.

In addition, a polymer multilayer structure with a metallic feel is proposed, in which each of the two or more different types of polymers includes:
(i) a thermoplastic resin selected from acrylic-based resins, olefin-based resins, vinyl-based resins, styrene-based resins, fluorine-based resins, and cellulose-based resins, or
(i) a thermosetting resin selected from phenol resins, epoxy resins, and polyimide resins.

In addition, a polymer multilayer structure with a metallic feel is proposed, in which at least one polymer layer included in the polymer multilayer structure with the metallic feel includes at least one type of plate-like nanoparticles selected from the group consisting of montmorillonite (MMT), pyrophyllite-talc, fluorohectorite, kaolinite, vermiculite, illite, and mica.

In another aspect of the disclosure, as an embodiment of the present disclosure for a method of manufacturing a polymer multilayer structure with a metallic feel, proposed is a method of manufacturing a polymer multilayer structure with a metallic feel, the method including:
(a) manufacturing film-shaped molded bodies each containing a polymer selected from two or more different types and having a refractive index that differs by 0.3 or more from other polymers, on a condition that at least one of the molded bodies contains guanine as a plate-like pigment,
(b) manufacturing a film having a predetermined thickness in a range of 95 to 195 nm by stretching each of the molded bodies prepared in the step (a), and
(c) manufacturing a multilayer structure by alternately stacking the film prepared in the step (b).

### Advantageous Effects

A method of manufacturing a polymer multilayer structure with a metallic feel according to the present disclosure can solve problems such as weak adhesion between metallic thin fins and polymer surfaces. The weak adhesion results from the technology of plating and painting metal particles on the surface of polymer materials to impart a metallic feel to polymer materials such as conventional plastics. The method can also solve problems like corrosiveness and toxicity issues arising from the use of some metal particles. At the same time, the method makes it possible to realize polymer-based materials with a metallic feel that has a reflectance of 80% or more in the visible light wavelength range (380 to 780 nm). Thus, the method can be useful in the manufacture of materials that can be widely used in various fields such as automobile interior materials, home appliances, and beauty packaging that require aesthetics.

### DESCRIPTION OF DRAWINGS

FIG. 1 is a cross-sectional schematic diagram of an example of a polymer multilayer structure with a metallic feel according to the present disclosure.

### DETAILED DESCRIPTION

In describing the present disclosure, when it is determined that a detailed description of a related known function or configuration may unnecessarily obscure the gist of the present disclosure, the detailed description will be omitted.

Since the embodiments according to the concept of the present disclosure can be variously changed and have various forms, specific embodiments will be illustrated in the drawing and described in detail in the present specification or application. However, this is not intended to limit the embodiments according to the concept of the present disclosure to a specific disclosed form and should be understood to include al changes, equivalents, and substitutes included in the spirit and technical scope of the present disclosure.

The terms used herein are only used to describe specific embodiments and are not intended to limit the disclosure. Singular expressions include plural expressions unless the context clearly dictates otherwise. In this specification, terms such as “include” or “have” are intended to indicate the existence of a described feature, number, step, operation, component, part, or combination thereof, but are not intended to indicate the presence of one or more other features or numbers. It should be understood that this does not exclude in advance the possibilty of the existence or addition of steps, operations, components, parts, or combinations thereof.

Optical thin films can change the spectral properties of the optical surface thereof such as reflectance, transmittance, absorption, polarization, phase, and color to suit purposes by using the interference effect of light and the optical properties of the medium. The optical thin films are designed by deciding the refractive index, thickness, and number of layers of the material. The optical thin films are used for anti-reflection (AR) coating, high reflection (HR) coating, short wave passing, and long wave passing. Anti-reflective coating on glasses is a representative application of the optical thin films.

The optical properties of a material are expressed by an optical constant N, and N is a complex refractive index expressed as N=n-ik by using the refractive index and an extinction coefficient k. In the case of dielectric thin films, the refractive index thereof is higher than the extinction coefficient, and the extinction coefficient is close to 0. For example, the refractive index of glass is 1.5, TiO₂ is 2.35, and SiO₂ is 1.46. A relationship between a refractive index and reflectance is

$$R = {( \frac{1 - n}{1 + n} )}^{2} ,$$

and in the case of dielectric thin films, the low reflectance, high transmittance, and absorption thereof are close to 0. In contrast, metallic thin films show the opposite characteristic. In the case of silver (Ag), the complex refractive index is expressed as 0.05−i4.0, and in the case of aluminum (A), the complex refractive index is expressed as 0.82−i6.0, and an extinction coefficient tends to be higher than a raw refractive index. A reflectance in metallic thin films is expressed as

$$R - \frac{{( 1 - n )}^{2} + {k}^{2}}{{( 1 \text{?} n )}^{2} \text{?} {k}^{2}} .$$

$$\text{?} \text{indicates text missing or illegible when filed}$$

The metallic thin films exhibit high reflectance, low transmittance, and absorption. The absorption coefficient of the metallic thin films is expressed as α, and α is expressed as

$$α = \frac{4 π k}{λ} .$$

For the intensity of light passing through the metallic thin films of thickness d, a relationship between an initial light intensity (I₀) and a light intensity (I) after passing through a thin film is expressed as I+I₀e^{-αd}, and an absorbed light intensity (I_{abs}) is expressed as I_{abs}=I₀(1-e^{-αd})≈αdI₀.

Optical admittance is a physical quantity that plays a very important role in design, deposition, and evaluation of properties of optical thin films and is defined as the ratio of a magnetic field to an electric field. When a plane wave with an angular frequency ω and a propagation vector K travels in a uniform and isotropic medium, the magnetic field and the magnetic field can be expressed as Ee^{i(ωt-K-r)} and He^{i(ωt-K-r)}, respectively, and E and H are the amplitudes of the electric and magnetic fields, respectively, and r is a position vector. When the wavelength of the plane wave in a vacuum is λ, a propagation vector in a medium with a complex refractive index N is expressed as

$$\text{?} = \frac{2 π}{λ} N \hat{s} .$$

$$\text{?} \text{indicates text missing or illegible when filed}$$

At this time, ŝ is a unit vector representing the direction of propagation. When these electric and magnetic fields' values are substituted into Maxwell's equations, operators can be expressed as ∇⇒-iK and

$$\begin{matrix}round \\ roundt\end{matrix} ⇒ i ω ,$$

and through this, the electric and magnetic fields can be expressed as

$$H = \frac{N}{c {μ}_{0}} ( \hat{s} \times E ) .$$

In an isotropic material, ŝ and E are perpendicular to each other, so the magnitude of the electric and magnetic fields becomes expressed as

$$H = \frac{N}{c {μ}_{0}} E .$$

In the equations, the ratio of the magnetic field H and the electric field E is defined as optical admittance. Therefore, the optical admittance Y becomes expressed as

$$Y = \frac{H}{E} = {Ny}_{0} ,$$

and y₀ is the admittance of vacuum with N=1, expressed as

$${y}_{0} \sqrt{\begin{matrix}{ε}_{0} \\ {μ}_{0}\end{matrix}} - 2.6544 \times {10}^{- 3}$$

[siemens, S]. The unit of admittance is expressed as S or 1/Ω. The optical admittance of glass with a refractive index of 1.52 is expressed as 1.52^{y}^{₀}, and for the optical admittance of ZnS with a refractive index of 2.35, Y=2.35^{y} ^{₀}. The optical admittance of Ag, which has a complex refractive index expressed as N=0.05−i4.0, is expressed as Y=(0.05−i4.0)y₀.

Distributed Bragg reflectors (DBR) are multilayer reflectors made from two materials with different refractive indices, typically 5 to 50 cycles. Fresnel reflection occurs at each interface due to the refractive index difference. Usually, the refractive index difference between the two materials is small, so the Fresnel reflection degree at one interface is very small. However, many DBRs are made from many interfaces, and the thickness of the two materials may be chosen so that al reflected waves can interfere constructively. When the refractive index difference between the two materials is large and the constructive interference effect at one interface increases, a reflectivity close to 1 can be obtained. This condition is satisfied when, for normal incidence, the thickness of the two materials is ¼ the wavelength of light. In the case of the normal incidence, the thickness is obtained as follows.

$$\text{?} = \text{?} / 4 = {λ}_{0} / ( 4 \text{?} )$$

$$\text{?} \text{indicates text missing or illegible when filed}$$

The thickness given in the equation not only can be λ4, but can also be an odd integer multiple, such as λ4, 3λ4, 5λ4, and 7λ4. These thicknesses will cause constructive interference of reflected waves. However, for layer thicknesses greater than λ4, such as 3λ4, the high reflectivity cutoff band becomes narrower. For angles of oblique incidence, a wave vector can be separated into horizontal and vertical components.

In the case of oblique incidence, as in normal incidence, the thickness of the DBR layer is required to be ¼ wavelength for the wave vector component perpendicular to the DBR layer. The optimal thickness for high reflectivity at an angle of oblique incidence (θ) is given as follows.

$$\text{?} = \text{?} / ( 4 cos \text{?} ) = {λ}_{0} / ( 4 \text{?} cos \text{?} )$$

$$\text{?} \text{indicates text missing or illegible when filed}$$

As with normal incidence, the given thickness, which is T_{l,h} can be an odd integer multiple of the given value.

Guanine crystals are widely used in nature to manipulate light. The reason why guanine crystals appear silver in nature is because they have high reflectivity in a wide band. The high reflectivity of natural optical systems made of guanine comes because they have a very high refractive index (n=1.83). In addition, to optimize reflectance, in most organisms, guanine's high refractive index surface forms single crystals in a plate-like form. Guanine, which is present in the scales of cutlassfish, also controls the reflection of incident light, providing the fish with a silvery or metallic color.

In addition, guanine has optical anisotropy. The high refractive index of guanine occurs along the crystal axis corresponding to the stacking direction of guanine molecules, while the refractive index along the orthogonal direction is estimated to be much lower at around n=1.45. In other words, the refractive index is clearly different depending on the stacking direction of guanine molecules. Therefore, when the orientation is varied on the basis of the crystal axis of guanine, the refractive index will show a diverse distribution in a range of 1.45 to 1.83.

Applying this, when the refractive index of the polymer matrix is about 1.4, and when the refractive index of guanine is 1.45, the refractive index difference is small, resulting in a low reflectance. Meanwhile, when the refractive index of guanine is 1.83, the refractive index difference is large, resulting in a high reflectance. Therefore, the refractive index can be adjusted by controlling the orientation using the anisotropy of the guanine crystal, and through this, the reflectance can be adjusted.

Based on the principles described above, the present disclosure proposes a polymer multilayer structure with a metallic feel, in which the polymer multilayer structure includes a plurality of polymer layers having respectively different types of polymers, the plurality of polymer layers being stacked alternately. Herein, the refractive index difference among the polymers satisfies the condition of a predetermined value of (0.3) or more. Furthermore, for biomimicry of the appearance of a silvery luster due to plate-like guanine contained in the skin layer of the cutlassfish and shown on the surface of a cutlassfish, at least one of the polymer layers includes guanine as a plate-like pigment.

At this time, it is preferable that among the polymer layers constituting the polymer multilayer structure with the metallic feel, the polymer contained in the guanine-containing polymer layer and guanine have a refractive index difference of 0.3 or more.

In addition, proposed is a polymer multilayer structure with a metallic feel, in which each polymer layer constituting the polymer multilayer structure with the metallic feel has a predetermined optical thickness within the range of ¼ of the visible light wavelength, that is, 95 to 195 nm, independently of other polymer layers such as neighboring polymer layers.

In other words, the polymer multilayer structure with a metallic feel according to the present disclosure has regularity in that polymer layers thereof containing different polymers are alternately stacked. Meanwhile, the thickness of each polymer layer is not related to the thickness of other polymer layers and has a predetermined value within a certain range (95 to 195 nm) independently. Thus, the thickness of the polymer layers appears randomly when arranged without forming a gradient in the thickness direction of the polymer multilayer structure.

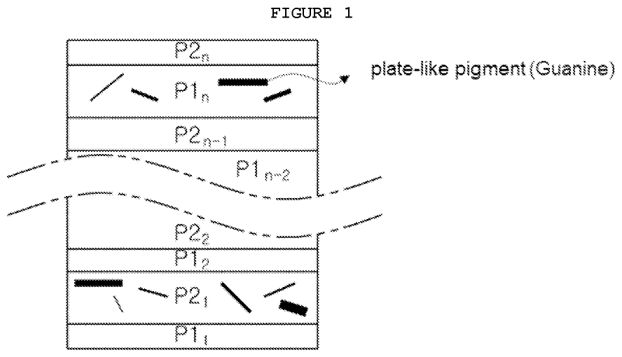

FIG. 1 is a cross-sectional schematic diagram of an example of a polymer multilayer structure with a metallic feel according to the present disclosure. Referring to FIG. 1, the polymer multilayer structure has a structure of polymer layers P1₁, P1₂, . . . P1ₙ₋₁, and P1ₙ which are made of a first polymer P1 and polymer layers P2₁, P2₂, . . . P2ₙ₋₁, and P2ₙ made of a second polymer P2 are arranged alternately. Meanwhile, guanine is randomly dispersed as a plate-like pigment in some of the polymer layers. FIG. 1 shows the polymer multilayer structure in which each polymer layer of the structure has a random thickness in a range of 95 to 195 nm independently of each other, and a random thickness arrangement of the layers appears.

Meanwhile, a method of manufacturing the polymer multilayer structure according to the present disclosure is not particularly limited. For example, the method may include:
(a) manufacturing two or more molded bodies containing a film-shaped first polymer of polyvinyl alcohol (PVA), and the like and two or more molded bodies containing a film-shaped second polymer of triacetyl cellulose (TAC), and the like respectively,
(b) manufacturing first polymer-containing films and second polymer-containing films having a predetermined thickness in the range of 95 to 195 nm by stretching the first polymer-containing molded bodies and the second polymer-containing molded bodies, respectively, and
(c) manufacturing a multilayer structure by alternately stacking the first polymer-containing films and second polymer-containing films.

Each of the polymers from two or more different types and included in each of the polymer layers which constitute the polymer multilayer structure with a metallic feel according to the present disclosure is made from a thermoplastic resin or thermosetting resin.

More specifically, the thermoplastic resin may include olefin-based resins such as polyethylene, polypropylene, poly-4-methylpentene-1, and acrylic-based resins such as polymethylmethacrylate and acrylonitrile, vinyl-based resins such as polyvinylchloride, polyvinylacetate, polyvinylalcohol, polyvinyl butyral, and polyvinyldenumchloride, styrene-based resins such as polystyrene and ABS resin, fluorine resins such as tetrafluoroethylene resin, trifluoroethylene resin, polyvinyldenumfluoride, and polyvinylfluoride, cellulose-based resins such as nitrocellulose, cellulose acetate, ethylcellulose, and propylene cellulose. In addition, polyamide, polyamidoimide, polyacetal, polycarXbonate, polyethylenebutarate, polybutylenebutarate, ionomo resin, polysulfone, polyethersulfone, polyphenyleneether, polyphenylenesulfide, polyetherimide, polyetheretherketone, and aromatic polyester (econol and polyarylate) may be used as the thermoplastic resin.

Additionally, the thermosetting resin may include phenol resins, epoxy resins, and polyinide resins.

In addition, to enhance and/or improve the optical properties, such as reflectance, of the polymer multilayer structure with a metallic feel according to the present disclosure, at least one polymer layer included in the multilayer structure may include one or more types of plate-like nanoparticles selected from the group consisting of montmorilonite (MMT), pyrophyllite-talc, fluorohectorite, kaolinite, vermiculite, illite, and mica.

As an example of the polymer multilayer structure with a metallic feel containing guanine according to the present disclosure, the polymer of the layer is manufactured through the alternative stacking of high refractive index polymers with relatively high refractive index and low refractive index polymers. The refractive index difference between the high refractive index polymer and the low refractive index polymer is 0.3 or more, and at this time, the plate-like pigment is included in the low refractive index material layer. The number of stacked polymer films of the multilayer structure is 257, and the plate-fie pigment is contained in an amount of 0.1% to 10% by weight in the low refractive index material layer based on the total weight of the layer. For example, when a nanostructure body is formed by stacking a melamine film and a Teflon film, the melamine film is a high refractive index material, and the Teflon film is a low refractive index material. In this case, guanine which is a high refractive index plate-like pigment is added when manufacturing the Teflon film, which is a low refractive index material.

With the described polymer multilayer structure with a metallic feel according to the present disclosure, a problem can be solved such as weak adhesion between metallic thin films and polymer surfaces. The weak adhesion results from the technology of plating and painting metal particles on the surface of polymer materials, the technology being used to impart a metallic feel to polymer materials such as conventional plastics. Problems like corrosiveness and toxicity issues arising from the use of some metal particles can also be solved. At the same time, the technology of the polymer multilayer structure makes it possible to realize polymer-based materials with a metallic feel that have a reflectance of 80% or more in the visible light wavelength range (380 to 780 nm). Thus, the polymer multilayer structure can be useful in various fields such as automobile interior materials, home appliances, and beauty packaging that require aesthetics.

Herein above, examples of the present disclosure have been described with reference to the attached drawings, but those skilled in the art to which the present disclosure pertains will understand that the present disclosure can be implemented in other specific forms without changing its technical idea or essential features. Therefore, the examples described above should be understood as illustrative in al respects and not restrictive.

### Industrial Applicability

A method of manufacturing a polymer multilayer structure with a metallic feel according to the present disclosure makes it possible to realize polymer-based materials with a metallic feel that have a reflectance of 80% or more in the visible light wavelength range (380 to 780 nm). Thus, the method can be useful in the manufacture of materials that can be widely used in various fields such as automobile interior materials, home appliances, and beauty packaging that require aesthetics.

1. A polymer multilayer structure with a metallic feel, the multilayer structure comprising two or more polymer layers comprising respectively different types of polymers having respective refractive indices that differ by 0.3 or more, the two or more polymer layers being stacked alternately,
wherein each of the two or more polymer layers has a predetermined thickness in a range of 95 to 195 nm, independently of each other, and
at least one polymer layer of the two or more polymer layers contains guanine as a plate-like pigment.

2. The polymer multilayer structure of claim 1, wherein the polymer contained in the polymer layer containing guanine and the guanine have a refractive index difference of 0.3 or more.

3. The polymer multilayer structure of claim 1, wherein each of the polymers comprises:
(i) a thermoplastic resin selected from acrylic-based resins, olefin-based resins, vinyl-based resins, styrene-based resins, fluorine-based resins, and cellulose-based resins, or
(ii) a thermosetting resin selected from phenol resins, epoxy resins, and polyinide resins.

4. The polymer multilayer structure of claim 1, wherein at least one polymer layer of the two or more polymer layers comprises at least one type of plate-like nanoparticles selected from the group consisting of montmorilonite (MMT), pyrophyllite-talc, fluorohectorite, kaolinite, vermiculite, rite, and mica.

5. A method of manufacturing a polymer multilayer structure with a metallic feel, the method comprising:
(a) manufacturing film-shaped molded bodies each containing a polymer selected from two or more different types and having a refractive index that differs by 0.3 or more from other polymers, on a condition that at least one of the molded bodies contains guanine as a plate-like pigment,
(b) manufacturing a film having a predetermined thickness in a range of 95 to 195 nm by stretching each of the molded bodies prepared in the step (a), and
(c) manufacturing a multilayer structure by alternately stacking the film prepared in the step (b).
